(19) United States
(12) Patent Application Publication
(10) Pub. No.: US 2010/0126386 A1
(43) Pub. Date: May 27, 2010

(54) RADIATION-CURABLE COATING SUBSTANCES

(75) Inventors: Sylke Haremza, Neckargemuend (DE); Michael Bueschel, Ludwigshafen (DE); Gerhard Wagenblast, Wachenheim (DE); Erich Beck, Ladenburg (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: Basf Aktiengesellschaft, Ludwigshafen (DE)

(21) Appl. No.: 11/720,788

(22) PCT Filed: Dec. 1, 2005
(86) PCT No.: PCT/EP05/12795

§ 371 Date: Jun. 4, 2007

(30) Foreign Application Priority Data
Dec. 3, 2004 (DE) 10 2004 058 584.9

(51) Int. Cl. C01B 21/00; C09K 3/00

(52) U.S. Cl. 106/287.21; 252/182.3; 252/182.12

(57) ABSTRACT

The invention relates to radiation-curable coating substances containing NIR photoinitiators, to novel formulations of NIR photoinitiators and to the use of said substances.

The present invention relates to radiation-curable coating materials comprising NIR photoinitiators, to new formulations of NIR photoinitiators, and to the use thereof.

EP 408 322 describes one-component photoinitiators in the form of salts comprising cyanine dye and defined boronate ions.

Likewise known are one-component photoinitiator systems in which cyanine, xanthylium or thiazine dyes are used as cation and a boronate compounds is used as anion; see EP-A 223 587, for example.

A feature common to all of these prior art systems is that they have a relatively low solubility in paints and, particularly if they precipitate in the form of crystals, they lead to defects in the paint finish.

This invention describes two-component NIR photoinitiator systems which comprise at least one sensitizer dye, also called sensitizer, and at least one free-radical initiator, also called coinitiator.

The prior art frequently uses, as sensitizer dyes, particularly cyanine, xanthylium or thiazine dyes and, as coinitiators, for example, boronate salts, sulfonium salts, iodinium salts, sulfones, peroxides, pyridine N-oxides or halomethyltriazines.

Cyanine dyes are composed of a cyanine cation and a corresponding anion. This can be a separate anion or else an internal anion; in other words, such that the anionic group is chemically connected to the cyanine cation. Normally they are obtained in the course of their preparation as simple salts, such as halides, tetrafluoroborates, perchlorates or tosylates, for example. Cyanine dyes with anions containing long-chain alkyl or alkyl-substituted aryl groups have not been disclosed to date. Cyanine dyes are available commercially.

Cyanine dyes are frequently used as alkyl- and aryl-sulfonates, sulfates, chlorides or the like, as known, for example, from U.S. Pat. No. 6,014,930 or EP-A 342 576.

DE-A 197 30 498 and DE-A 196 48 256 disclose compositions which are prepared from the separate salts of a cationic dye and boronate salts and which can also be used in mixtures with UV photoinitiators.

The German patent application with the file reference 10 2004 011 347.5 describes cyanine dyes as NIR absorbers for laser radiation, which in printing inks have a minimum solubility of 0.1% by weight and which as counterions may contain borates that carry, on the central boron atom, substituents attached via four oxygen atoms. Borates of this kind, however, are photochemically inactive and are unable to function as photoinitiators.

It was an object of the present invention to provide NIR photoinitiator systems which on the one hand have good solubility and on the other hand have good photoactivability by NIR radiation.

This object has been achieved by means of mixtures comprising
(A) at least one absorber, ionic in construction, comprising a cyanine cation Cya⁺ and a corresponding anion ¹/ₘ An^{m-}, the cyanine cation having a general formula (I), (II), (III) or (IV)

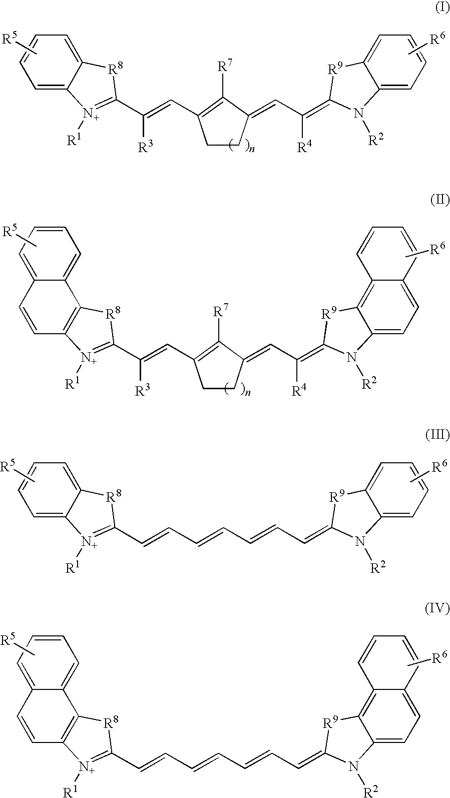

in which
n is 1 or 2 and the radicals R¹ to R⁹ are defined as follows:
R¹ and R² independently of one another are each a linear or branched, optionally further-substituted alkyl or aralkyl radical having 1 to 20 carbon atoms,
R³ and R⁴ independently of one another are each M. CF₃ or CN.
R⁵ and R⁶ independently of one another are one or more identical or different substituents selected from the group consisting of —H, —F, —Cl, —Br, —I, —NO₂, —CN, —CF₃, —SO₂CF₃, —R¹, —OR¹, aryl and —O-aryl,
R⁷ is —H, —Cl, —Br, —I, -phenyl, —O-phenyl, —S-phenyl, —N(phenyl)₂, -pyridyl, a barbituric acid radical or a dimedone radical, it also being possible for the phenyl radicals to be further substituted, and
R⁸ and R⁹ independently of one another are each >C(CH₃)₂, —O—, —S—, >NR¹ or —CH═CH—,
and the anion An^{m-} having the general formula [AR¹⁰ₖ]^{m-} with a polar ionic head group A and k nonpolar groups R¹⁰, in which
k is a number 1, 2 or 3,
m is 1 or 2,
and the nonpolar groups R¹⁰ are selected independently of one another from the group consisting of
   linear, branched and cyclic alkyl groups having 6 to 30 carbon atoms and
   alkylaryl groups of the general formula -aryl-R¹¹, R¹¹ being linear or branched alkyl groups having 3 to 30 carbon atoms,
or the anion An^{m-} being a borate anion of the general formula (V or (VI)

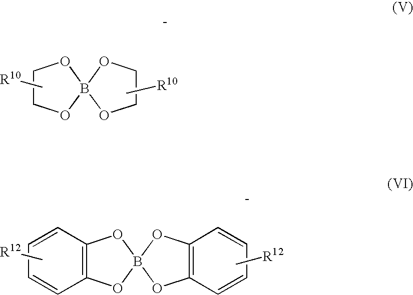

where R¹⁰ is as defined above and R¹² is at least one substituent selected from the group consisting of hydrogen and linear, cyclic or branched alkyl groups having 1 to 20 carbon atoms, and
it also being possible, in the radicals R¹⁰, R¹¹ and R¹², for nonadjacent carbon atoms optionally to be substituted by oxygen atoms, and/or for the radicals R¹⁰, R¹¹ and R¹² to be fully or partly fluorinated, with the proviso that this does not substantially affect the nonpolar nature of the groups, and
   (B) at least one coinitiator of the formula (VII)

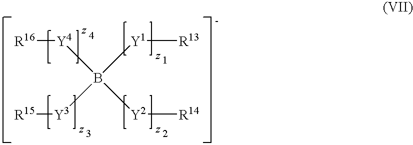

with an associated counterion ¹/ₓ cat^{x+},
in which
x is 1 or 2,
cat is a cation,
z¹, z², z³ and z⁴ independently of one another are each 0 or 1,
the sum z¹+z²+z³+z⁴ being 0, 1, 2 or 3, preferably 0, 1 or 2, more preferably 0 or 1, and very preferably 0,
Y¹, Y², Y³ and Y⁴ independently of one another are each O, S or NR¹⁷,
R¹³, R¹⁴, R¹⁵ and R¹⁶ independently of one another are each C₁-C₁₈ alkyl, C₂-C₁₈ alkyl optionally interrupted by one or more oxygen and/or sulfur atoms and/or by one or more substituted or unsubstituted imino groups, or are each C₆-C₁₂ aryl, C₅-C₁₂ cycloalkyl or a five- to six-membered heterocycle containing oxygen, nitrogen and/or sulfur atoms, it being possible for the stated radicals to be substituted in each case by aryl, alkyl, aryloxy, alkyloxy, heteroatoms and/or heterocycles, and
R¹⁷ is hydrogen, C₁-C₁₈ alkyl or C₆-C₁₂ aryl,
with the proviso that at least one of the radicals R¹³ to R¹⁶ is a C₁-C₁₈ alkyl radical and at least one of the radicals R¹³ to R¹⁶ is a C₆-C₁₂ aryl radical, it being possible for the stated radicals to be substituted in each case by aryl, alkyl, aryloxy, alkyloxy, heteroatoms and/or heterocycles.

Definitions therein are as follows:

C₁-C₁₈ alkyl optionally substituted by aryl, alkyl, aryloxy, alkyloxy, heteroatoms and/or heterocycles is for example methyl, ethyl, propyl, isopropyl, n-butyl, sec-butyl, tert-butyl, pentyl, hexyl, heptyl, octyl, 2-ethylhexyl, 2,4,4-trimethylpentyl, decyl, dodecyl, tetradecyl, heptadecyl, octadecyl, 1,1-dimethylpropyl, 1,1-dimethylbutyl, 1,1,3,3-tetramethylbutyl, benzyl, 1-phenylethyl, 2-phenylethyl, α,α-dimethylbenzyl, benzhydryl, p-tolylmethyl, 1-(p-butylphenyl)-ethyl, p-chlorobenzyl, 2,4-dichlorobenzyl, p-methoxybenzyl, m-ethoxybenzyl, 2-cyanoethyl, 2-cyanopropyl, 2-methoxy carbonylethyl, 2-ethoxycarbonylethyl, 2-butoxycarbonylpropyl, 1,2-di(methoxycarbonyl)ethyl, 2-methoxyethyl, 2-ethoxyethyl, 2-butoxyethyl, diethoxymethyl, diethoxyethyl, 1,3-dioxolan-2-yl, 1,3-dioxan-2-yl, 2-methyl-1,3-dioxolan-2-yl, 4-methyl-1,3-dioxolan-2-yl, 2-isopropoxyethyl, 2-butoxypropyl, 2-octyloxyethyl, chloromethyl, 2-chloroethyl, trichloromethyl, trifluoromethyl, 1,1-dimethyl-2-chloroethyl, 2-methoxyisopropyl, 2-ethoxyethyl, butylthiomethyl, 2-dodecylthioethyl, 2-phenylthioethyl, 2,2,2-trifluoroethyl, 2-hydroxyethyl, 2-hydroxypropyl, 3-hydroxypropyl, 4-hydroxybutyl, 6-hydroxyhexyl, 2-aminoethyl, 2-aminopropyl, 3-aminopropyl, 4-aminobutyl, 6-aminohexyl, 2-methylaminoethyl, 2-methylaminopropyl, 3-methylaminopropyl, 4-methylaminobutyl, 6-methylaminohexyl, 2-dimethylaminoethyl, 2-dimethylaminopropyl, 3-dimethylaminopropyl, 4-dimethylaminobutyl, 6-dimethylaminohexyl, 2-hydroxy-2,2-dimethylethyl, 2-phenoxyethyl, 2-phenoxypropyl, 3-phenoxypropyl, 4-phenoxybutyl, 6-phenoxyhexyl, 2-methoxyethyl, 2-methoxypropyl, 3-methoxypropyl, 4-methoxybutyl, 6-methoxyhexyl, 2-ethoxyethyl, 2-ethoxypropyl, 3-ethoxypropyl, 4-ethoxybutyl or 6-ethoxyhexyl,
C₂-C₁₈ alkyl optionally interrupted by one or more oxygen and/or sulfur atoms and/or by one or more substituted or unsubstituted imino groups is for example 5-hydroxy-3-oxa-pentyl, 8-hydroxy-3,6-dioxa-octyl, 11-hydroxy-3,6,9-trioxa-undecyl, 7-hydroxy-4-oxa-heptyl, 11-hydroxy-4,8-dioxa-undecyl, 15-hydroxy-4,8,12-trioxa-pentadecyl, 9-hydroxy-5-oxa-nonyl, 14-hydroxy-5,10-oxa-tetradecyl, 5-methoxy-3-oxa-pentyl, 8-methoxy-3,6-dioxa-octyl, 11-methoxy-3,6,9-trioxa-undecyl, 7-methoxy-4-oxa-heptyl, 11-methoxy-4,8-dioxa-undecyl, 15-methoxy-4,8,12-trioxa-pentadecyl, 9-methoxy-5-oxa-nonyl, 14-methoxy-5,10-oxa-tetradecyl, 5-ethoxy-3-oxa-pentyl, 8-ethoxy-3,6-dioxa-octyl, 11-ethoxy-3,6,9-trioxa-undecyl, 7-ethoxy-4-oxa-heptyl, 11-ethoxy-4,8-dioxa-undecyl, 15-ethoxy-4,8,12-trioxa-pentadecyl, 9-ethoxy-5-oxa-nonyl or 14-ethoxy-5,10-dioxa-tetradecyl.

The number of oxygen and/or sulfur atoms and/or imino groups is not restricted. In general the number is not more than 5 per radical, preferably not more 4 and very preferably not more than 3.

Furthermore, there is generally at least one carbon atom, and preferably at least two, between two heteroatoms.

Substituted and unsubstituted imino groups may be, for example, imino, methylimino, iso-propylimino, n-butylimino or tert-butylimino groups.

Further definitions are as follows:

C₆-C₁₂ aryl optionally substituted by aryl, alkyl, aryloxy, alkyloxy, heteroatoms and/or heterocycles is for example phenyl, tolyl, xylyl, α-naphthyl, β-naphthyl, 4-biphenylyl, chlorophenyl, dichlorophenyl, trichlorophenyl, difluorophenyl, methylphenyl, dimethylphenyl, trimethylphenyl, ethylphenyl, diethylphenyl, iso-propylphenyl, tert-butylphenyl, dodecylphenyl, methoxyphenyl, dimethoxyphenyl, ethoxyphenyl, hexyloxyphenyl, methylnaphthyl, isopropylnaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2- or 4-nitrophenyl, 2,4- or 2,6-dinitrophenyl, 4-dimethylaminophenyl, 4-acetylphenyl, methoxyethylphenyl or ethoxymethylphenyl,
C₅-C₁₂ cycloalkyl optionally substituted by aryl, alkyl, aryloxy, alkyloxy, heteroatoms and/or heterocycles is for example cyclopentyl, cyclohexyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, butylthiocyclohexyl, chlorocyclohexyl, dichlorocyclohexyl, dichlorocyclopentyl or a saturated or unsaturated bicyclic system such as norbornyl or norbornenyl, for example, and
a five- to six-membered heterocycle containing oxygen, nitrogen and/or sulfur atoms is for example furyl, thiophenyl, pyrryl, pyridyl, indolyl, benzoxazolyl, dioxolyl, dioxyl, benzimidazolyl, benzothiazolyl, dimethylpyridyl, methylquinolyl, dimethylpyrryl, methoxyfuryl, dimethoxypyridyl, difluoropyridyl, methylthiophenyl, isopropylthiophenyl or tert-butylthiophenyl.

Y¹, Y², Y³ and Y⁴ independently of one another are each preferably oxygen or NR¹⁷ and more preferably oxygen.

R¹⁷ is preferably hydrogen or C₁-C₄ alkyl.

C₁ to C₄ alkyl stands in this specification for methyl, ethyl, propyl, isopropyl, n-butyl, sec-butyl or tert-butyl, preferably for methyl, ethyl or n-butyl, more preferably for methyl or ethyl and very preferably for methyl.

R¹³, R¹⁴, R¹⁵ and R¹⁶ are preferably independently of one another in each case C₁-C₁₈ alkyl, C₆-C₁₂ aryl or C₅-C₁₂ cycloalkyl, more preferably C₁-C₁₈ alkyl and C₆-C₁₂ aryl, very preferably selected from the group consisting of methyl, ethyl, propyl, isopropyl, n-butyl, sec-butyl, tert-butyl, pentyl, hexyl, heptyl, octyl, 2-ethylhexyl, 2,4,4-trimethylpentyl, decyl, dodecyl, tetradecyl, heptadecyl, octadecyl, 1,1-dimethylpropyl, 1,1-dimethylbutyl, 1,1,3,3-tetramethylbutyl, benzyl, 1-phenylethyl, 2-phenylethyl, α,α-dimethylbenzyl, benzhydryl, p-tolylmethyl, 1-(p-butylphenyl)-ethyl, phenyl, tolyl, xylyl, α-naphthyl, β-naphthyl, 4-biphenylyl, methylphenyl, dimethylphenyl, trimethylphenyl, ethylphenyl, diethylphenyl, iso-propylphenyl, tert-butylphenyl and dodecylphenyl, selected in particular from the group consisting of methyl, ethyl, propyl, n-butyl, hexyl, octyl, 2-ethylhexyl, dodecyl, benzyl, 2-phenylethyl, phenyl, tolyl, α-naphthyl and β-naphthyl, and especially selected from the group consisting of methyl, ethyl, n-propyl, n-butyl, benzyl, phenyl and tolyl.

In accordance with the invention, at least one of the radicals R¹³ to R¹⁶ is C₁-C₁₈ alkyl and at least one is C₆-C₁₂ aryl; preferably at least one is C₁-C₁₈ alkyl and at least one is C₆-C₁₂ aryl and the other two are likewise selected from the group comprising C₁-C₁₈ alkyl and C₆-C₁₂ aryl; more preferably at least one is C₁-C₁₈ alkyl and at least two are C₆-C₁₂ aryl; and very preferably one is C₁-C₁₈ alkyl and three are C₆-C₁₂ aryl.

The amount of sensitizer dye comprised in the coating material of the invention is chosen by the skilled worker so as to obtain sufficient photocuring of the coating material. As a general rule, an amount of less than 5% by weight is sufficient. An amount which has proven particularly appropriate is from 0.05% to 4% by weight, relative to the sum of all of the components of the coating material; preferably 0.1% to 3%, more preferably 0.2% to 2.5%, and very preferably 0.3% to 2.0% by weight. In accordance with the invention it must be ensured that added sensitizer dye is fully dissolved in the coating material.

The solubility of the sensitizer dye in the coating material is preferably at least 0.2%, more preferably at least 0.5%, very preferably at least 1.0% and, for example, at least 2% by weight.

In the invention the sensitizer dye is an absorber of ionic construction, comprising a cyanine cation Cya⁺ and a corresponding anion ¹/ₘ An^{m-}, where m can adopt in particular the values 1 or 2.

The cyanine cation according to the invention has a general formula selected from the formulae (I) to (IV) below:

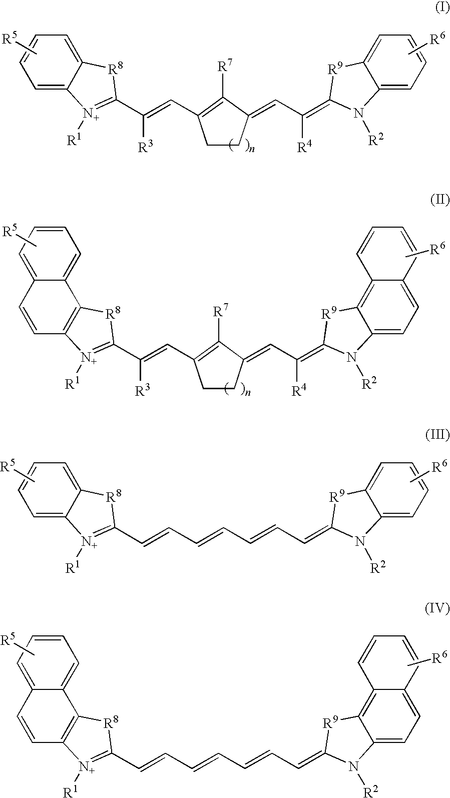

In these formulae, n is 1 or 2 and the radicals R¹ to R⁹ have the following definition:

R¹ and R² independently of one another are each a linear or branched alkyl or aralkyl radical having 1 to 20 carbon atoms. Examples comprise methyl, ethyl, 1-propyl, 2-propyl, 1-butyl, 2-butyl, t-butyl, 1-pentyl, 1-hexyl, 2-ethyl-1-hexyl, 1-octyl, 1-decyl or 1-dodecyl groups. In particular they are linear alkyl groups. Preferred radicals are methyl, ethyl, 1-butyl or 1-dodecyl groups. Aralkyl groups are, in principle, alkyl groups substituted by aryl groups. Examples comprise a benzyl or phenylethyl group. R¹ and R² may be alike or different from one another. Preferably R¹ and R² are radicals that are alike.

R¹ and R² may optionally be further substituted. Particular mention may be made here of functional groups such as amino or hydroxyl groups, for example. If present, such groups may in particular be functional groups disposed terminally on alkyl groups.

R³ and R⁴ independently of one another are each —H, CF₃ or —CN. Preferably R³ and R⁴ are the same group.

The radicals R⁵ and R⁶ are different or, preferably, identical radicals selected from the group consisting of —H, —F, —Cl, —Br, —I, —NO₂, —CN, —CF₃ and —SO₂CF₃. R⁵ and R⁶ can also be a radical —R¹ or —OR¹, where R¹ has in each case the definition shown above. In addition, the radicals in question may also be aryl or —O-aryl radicals, aryl being preferably a phenyl radical. Preferably R⁵ and R⁶ are —H, —Cl, —Br or —I or are an alkyl radical. The terminal rings may in each case also have two or more identical or different substituents R⁵ or R⁶, respectively, at different positions of the ring. Preferably there are not more than two substituents on each ring, and more preferably only one is present in each case.

R⁷ can be —H, —Cl, —Br, —I, -phenyl, —O-phenyl, —S-phenyl, —N(phenyl)₂, -pyridyl, a barbituric acid radical or a dimedone radical, it also being possible for the phenyl radicals to be further substituted. In the case of further substituents they may be, for example, straight-chain or branched alkyl radicals, examples being methyl or ethyl radicals, or else may be —F, —Cl, —Br, —I, —NO₂, —CN or —CF₃.

The radicals R⁸ and R⁹ are different or, preferably, identical radicals selected from the group consisting of >C(CH₃)₂, —O—, —S—, >NR¹ or —CH═CH—. With particular preference they are >C(CH₃)₂.

The counterion An^{m-} to the cyanine cation can have the general formula [AR¹⁰ₖ]^{m-}. This comprises at least one polar ionic head group A and k nonpolar groups R¹⁰, k being a number 1, 2 or 3 and m being 1 or 2. Preferably the anion has only one group R¹⁰. With further preference it is a monovalent anion. Where two or more nonpolar groups R¹⁰ are present in the anion, they can be different or, preferably, identical. The counterion may of course also comprise a mixture of two or more different anions.

The groups R¹⁰ can be linear, branched or cyclic alkyl groups having 6 to 30 carbon atoms. Preferably the alkyl groups R¹⁰ have 6 to 12 carbon atoms. Examples of suitable groups comprise 1-hexyl, cyclohexyl, 2-ethyl-1-hexyl, 1-octyl, 1-nonyl, 1-decyl, 1-undecyl, 1-dodecyl or 1-tetradecyl groups. Preferably they are linear alkyl groups.

These groups may also be alkylaryl groups of the general formula -aryl-R¹¹, where R¹¹ is a linear or branched alkyl group having 3 to 30 carbon atoms. Examples of suitable groups comprise 1-propyl, 2-propyl, 1-butyl, 2-butyl, tert-butyl, 1-pentyl, 1-hexyl, cyclohexyl, 2-ethyl-1-hexyl, 1-octyl, 1-nonyl, 1-decyl, 1-undecyl, 1-dodecyl or 1-tetradecyl groups. Preferably the alkyl groups R¹¹ have 6 to 12 carbon atoms. More preferably they are linear alkyl groups.

The aryl unit is a group formed by formal abstraction of the corresponding number of hydrogen atoms from an aromatic hydrocarbon, preferably benzene or naphthalene.

The aryl unit is, in particular, a phenylene group, preferably a 1,4-phenylene group. Examples of suitable alkylaryl groups comprise —(C₆H₄)—C₃H₇, —(C₆H₄)—C₆H₁₃ or —(C₆H₄)—C₁₂H₂₅.

The polar ionic head group A is in particular the anion of a monovalent or divalent acid radical. This may be any organic or inorganic acid group. Preferably it is a carboxyl group or comprises S-, P- and/or B-containing acid groups. By way of example it may be an acid group selected from the group consisting of —SO₃⁻, —OSO₃⁻, —COO⁻, —PO₃²⁻, —OPO₃²⁻ or (—O)PO₂⁻.

Examples of particularly suitable anions comprise alkylsulfonates having alkyl radicals, especially linear alkyl radicals of 6 to 12 carbon atoms, such as, for example, n-octylsulfonate, n-decylsulfonate or n-dodecylsulfonate, and also 4-alkylbenzenesulfonates having alkyl radicals of 6 to 12 carbon atoms such as, for example, 4-hexylbenzenesulfonate, 4-octylbenzenesulfonate, 4-decylbenzenesulfonate or 4-dodecylbenzenesulfonate. These anions may in principle also comprise technical-grade products having a distribution of different alkyl radicals differing in length.

The counterion An^{m-} for the cyanine cation can also be a borate anion of the general formula (V) or (VI)

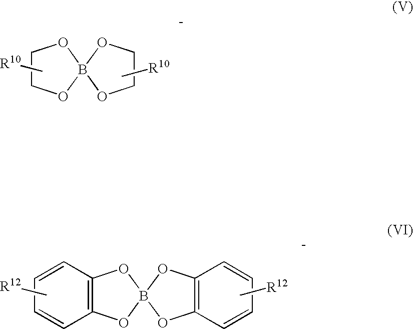

R¹⁰ is a radical as defined above. It is possible in each case for there to be one or two identical or different substituents on each of the chelate ligands. Preferably there is one substituent in each case. R¹² comprises in each case one or more identical or different substituents selected from the group consisting of H and linear, cyclic or branched alkyl groups having 1 to 20 carbon atoms, preferably a radical having 2 to 12 carbon atoms. Preferably there is only one alkyl group substituent. Borate anions of this kind are obtainable, for example, from boric acid and the corresponding dialcohol.

In the radicals R¹⁰, R¹¹ and R¹² it is also possible for nonadjacent carbon atoms to be optionally substituted by oxygen atoms and/or for the radicals R¹⁰, R¹¹ and R¹² to be fully or partly fluorinated, provided that this does not substantially alter the nonpolar character of the groups. In one preferred embodiment the radicals are unfluorinated.

The sensitizer dyes of the invention can be prepared by means of a variety of methods. They can be prepared, for example, by means of a two-stage process in which, in a first step, the cyanine cations are synthesized with customary anions such as iodide, tetrafluoroborate, perchlorate or para-toluenesulfonate. Preparation instructions are known to the skilled worker. As an example, reference may be made to DE-A 37 21 850, EP-A 627 660 and the literature cited therein. Sensitizer dyes based on cyanines are also available commercially.

Then, in a second step, the customary anions are replaced by the anions An^{m-} of the invention, using a suitable technique.

This can be done, for example, by charging the starting material, together with the corresponding acid HₘAn, to a water-immiscible organic solvent, it being necessary for the absorber to be insoluble therein. Particularly suitable organic solvents are those which are volatile and have a certain polarity. A possible example is dichloromethane. The organic solution or suspension is subsequently extracted with water until the original anion is completely removed from the organic solution. The sensitizer dye of the invention can obtained by removing the solvent from the solution.

The preparation can also be carried out using acidic ion exchange resins.

The ion exchange may also take place along the lines of the process disclosed by WO 03/76518.

In accordance with the invention the mixtures of the invention likewise comprise a component (B) comprising an anionic boron compound of the formula (VII).

These anionic boron compounds possess as their counterion an x-tuply positively charged cation cat^{x+}. Such cations may be, for example, alkali metal, alkaline earth metal or ammonium ions, e.g., Mg²⁺, Li⁺, Na⁺ or K⁺, but are preferably ammonium ions.

Ammonium ions for the purposes of the present invention are ionic compounds which comprise at least one tetrasubstituted nitrogen atom, the substituents being selected from C₁-C₁₈ alkyl and C₆-C₁₂ aryl and being preferably alkyl radicals. It is of course also possible for two or more substituents to be linked to form a ring, so that the quaternary nitrogen atom is part of a five- to seven-membered ring.

Examples of ammonium cations are tetra-n-octylammonium, tetramethylammonium, tetraethylammonium, tetra-n-butylammonium, trimethylbenzylammonium, trimethylcetylammonium, triethylbenzylammonium, tri-n-butylbenzylammonium, trimethylethylammonium, tri-n-butylethylammonium, triethylmethylammonium, tri-n-butylmethylammonium, diisopropyl-diethylammonium, diisopropylethylmethylammonium, diisopropylethylbenzylammonium, N,N-dimethylpiperidinium, N,N-dimethylmorpholinium, N,N-dimethylpiperazinium or N-methyldiazabicyclo[2.2.2]octane. Preferred alkylammonium ions are tetraoctylammonium, tetramethylammonium, tetraethylammonium and tetra-n-butylammonium, particular preference is given to tetraoctylammonium and tetra-n-butylammonium, and tetra-n-butylammonium is especially preferred.

Examples of ammonium ions comprising ring systems are methylated, ethylated, n-butylated, cetylated or benzylated piperazines, piperidines, imidazoles, morpholines, quinuclidines, quinolines, pyridines or triethylendiamines.

The mixtures of the invention comprise
at least one component (A) of the formula ¹/ₘ An^{m-} Cya⁺, as indicated above, and
at least one component (B), preferably of the formula (VII), with a counterion ¹/ₓ cat^{x+}.

The mixtures of the invention may comprise as component (B), instead of the anionic boron compounds of the formula (VII) with their counterion ¹/ₓ cat^{x+}, or additionally, sulfonium salts, iodonium salts, sulfones, peroxides, pyridine N-oxides or halomethyltriazines.

Suitable sulfonium salts are described for example in DE-A1 197 30 498, particularly on page 3 therein, in lines 28-39, that passage being hereby expressly incorporated into the present disclosure content by reference.

These salts are preferably salts of the formula

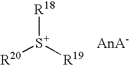

in which
R¹⁸ and R¹⁹ are each an optionally substituted aryl group and
R²⁰ is an optionally substituted alkyl group, an optionally substituted alkenyl group, an optionally substituted alicyclic group, an optionally substituted aryl group or an optionally substituted aralkyl group, and AnA⁻ is an anion.

Particular preference is given to triphenylsulfonium, diphenylanisylsulfonium, diphenyl(4-tolyl)sulfonium, diphenyl(4-fluorophenyl)sulfonium, diphenyl(4-(phenylthio)phenyl)sulfonium, diphenylbenzylsulfonium, diphenyl(4-chlorobenzyl)sulfonium, diphenyl(4-bromobenzyl)sulfonium, diphenyl(4-cyanobenzyl)sulfonium, di(4-tert-butylphenyl)benzylsulfonium, dianisyl(4-bromophenyl)sulfonium, diphenylphenacylsulfonium, diphenyl(4-chlorophenacyl)sulfonium, diphenyl(4-cyanophenacyl)sulfonium, diphenylallylsulfonium, diphenylmesylsulfonium, diphenyl-p-toluenesulfonylmethylsulfonium, diphenyl(dimethylsulfoniumylmethyl)sulfonium and diphenyl-[4-(diphenylsulfoniumyl)phenyl]sulfonium.

Preferred anions AnA⁻ are BF₄⁻, PF₆⁻, AsF₆⁻, SbF₆⁻, ClO₄⁻, Cl⁻, Br⁻, tetraphenylborate, tetrakis(pentafluorophenyl)borate, the benzenesulfonate anion, the p-toluenesulfonate anion and the trifluoromethanesulfonate anion.

Suitable iodonium salts are described for example in DE-A1 197 30 498, particularly on page 3 therein, in lines 40-43, that passage hereby being expressly incorporated into the present disclosure content by reference.

These salts are preferably salts of the formula

R²¹—I⁺—R²²AnB⁻

in which
R²¹ and R²² are optionally substituted aryl groups and AnB⁻ is an anion.

Particular preference is given to diphenyliodonium, anisylphenyliodonium, di(4-tert-butylphenyl)iodonium, di(4-chlorophenyl)iodonium, ditolyliodonium and di(3-nitrophenyl)iodonium.

Preferred anions AnB⁻ are BF₄⁻, PF₆⁻, AsF₆⁻, SbF₆⁻, ClO₄⁻, Cl⁻, Br⁻, tetraphenylborate, tetrakis(pentafluorophenyl)borate, the benzenesulfonate anion, the p-toluenesulfonate anion and the trifluoromethanesulfonate anion.

Suitable sulfones are described for example in DE-A1 197 30 498, particularly on page 4 therein, in lines 1-12, that passage being hereby expressly incorporated into the present disclosure content by reference.

These sulfones are preferably of the formula

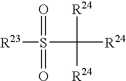

in which
R²³ is an optionally substituted aryl group and the radicals R²⁴ are each a halogen atom.

Halogen for the purposes of this specification comprises fluorine, chlorine, bromine and iodine, preferably chlorine and bromine and more preferably chlorine.

Particular preference is given to trichloromethyl phenyl sulfone, tribromomethyl phenyl sulfone, trichloromethyl 4-chlorophenyl sulfone, tribromomethyl 4-nitrophenyl sulfone, 2-trichloromethylbenzothiazole sulfone, 2,4-dichlorophenyl trichloromethyl sulfone, 2-methyl-4-chlorophenyl trichloromethyl sulfone and 2,4-dichlorophenyl tribromomethyl sulfone.

Suitable peroxides are described for example in DE-A1 197 30 498, particularly on page 4 therein, in lines 13-24, that passage being hereby expressly incorporated into the present disclosure content by reference.

These peroxides are preferably of the formula

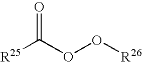

in which
R²⁵ is an optionally substituted aryl group and
R²⁶ is an optionally substituted alkyl group, an optionally substituted aryl group or an optionally substituted benzoyl group, preferably of the formula R²⁵—(CO)—.

Particular preference is given to benzoyl peroxide, 2,4-dichlorobenzoyl peroxide, tert-butyl peroxybenzoate, di(tert-butyl peroxy)isophthalate, di(tert-butyl peroxy)terephthalate, di(tert-butyl peroxy)phthalate, 2,5-dimethyldi(benzoylperoxy)hexane and 3,3′,4,4′-tetra(tert-butylperoxycarbonyl)benzophenone.

Suitable pyridine N-oxides are described for example in DE-A1 197 30 498, particularly on page 3 therein, in lines 44-62, that passage being hereby expressly incorporated into the present disclosure content by reference.

These N-oxides are preferably of the formula

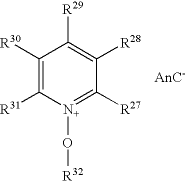

in which
R²⁷, R²⁸, R²⁹, R³⁰ and R³¹ independently of one another are each a hydrogen atom, a halogen atom, a cyano group, an optionally substituted alkyl group, an optionally substituted alkoxy group or an optionally substituted aryl group, R³² is an optionally substituted alkyl group, and AnC⁻ is an anion.

Particular preference is given to N-methoxypyridinium, N-ethoxypyridinium, N-methoxy-2-picolinium, N-methoxy-3-picolinium, N-ethoxy-2-picolinium, N-ethoxy-3-picolinium, N-methoxy-4-bromopyridinium, N-methoxy-3-bromopyridinium, N-methoxy-2-bromopyridinium, N-ethoxy-4-bromopyridinium, N-ethoxy-3-bromopyridinium, N-ethoxy-2-bromopyridinium, N-ethoxy-4-chloropyridinium, N-ethoxy-3-chloropyridinium, N-ethoxy-2-chloropyridinium, N-methoxy-4-methoxypyridinium, N-methoxy-3-methoxypyridinium, N-methoxy-2-methoxypyridinium, N-ethoxy-4-methoxypyridinium, N-ethoxy-3-methoxypyridinium, N-ethoxy-2-methoxypyridinium, N-methoxy-4-phenylpyridinium, N-methoxy-3-phenylpyridinium, N-methoxy-2-phenylpyridinium, N-ethoxy-4-phenylpyridinium, N-ethoxy-3-phenylpyridinium, N-ethoxy-2-phenylpyridinium, N-methoxy-4-cyanopyridinium, N-ethoxy-4-cyanopyridinium, N,N′-dimethoxy-4,4′-bipyridinium, N,N′-diethoxy-4,4′-bipyridinium, N,N′-dimethoxy-2,2′-bipyridinium and N,N′-diethoxy-2,2′-bipyridinium.

Preferred anions AnC⁻ are BF₄⁻, PF₆⁻, AsF₆⁻, SbF₆⁻, ClO₄⁻, Cl⁻, Br, tetraphenylborate, tetrakis(pentafluorophenyl)borate, the benzenesulfonate anion, the p-toluenesulfonate anion and the trifluoromethanesulfonate anion.

Suitable halomethyltriazines are described for example in DE-A1 197 30 498, particularly on page 4 therein, in lines 25-40, that passage being hereby expressly incorporated into the present disclosure content by reference.

These halomethyltriazines are preferably of the formula

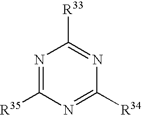

in which
R³³, R³⁴ and R³⁵ independently of one another are each a trihalomethyl group, an optionally substituted alkyl group, an optionally substituted alkenyl group or an optionally substituted aryl group, with the proviso that at least one of the groups is a trihalomethyl group.

Particular preference is given to 2,4,6-tris(trichloromethyl)-s-triazine, 2,4,6-tris(tribromomethyl)-s-triazine, 2,4-bis(dichloromethyl)-6-trichloromethyl-s-triazine, 2-propionyl-4,6-bis(trichloromethyl)-s-triazine, 2-benzoyl-4,6-bis(trichloromethyl)-s-triazine, 2-(4-cyanophenyl-4,6-bis(trichloromethyl)-s-triazine, 2-(4-nitrophenyl)-4,6-bis(trichloromethyl)-s-triazine, 2-(4-chlorophenyl-4,6-bis(trichloromethyl)-s-triazine, 2-(4-cumenyl)-4,6-bis(trichloromethyl)-s-triazine, 2-(4-aminophenyl)-4,6-bis(trichloromethyl)-s-triazine, 2,4-bis(4-methoxyphenyl)-6-trichloromethyl, 2,4-bis(3-chlorophenyl)-6-trichloromethyl-s-triazine, 2-(4-methoxystyryl(trichloromethyl)-s-triazine, 2-(4-chlorostyryl)-4,6-bis(trichloromethyl)-s-triazine, 2-(4-aminophenyl)-4,6-bis(trichloromethyl)-s-triazine, 2,4-bis(4-methoxyphenyl)-6-trichloromethyl-s-triazine, 2,4-bis(3-chlorophenyl)-6-trichloromethyl-s-triazine, 2-(4-methoxystyryl)-4,6-bis(trichloromethyl)-s-triazine, 2-(4-chlorostyryl)-4,6-bis(trichloromethyl)-s-triazine, 2-(4-aminostyryl)-4,6-bis(dichloromethyl)-s-triazine, 2-(4′-methoxy-1′-naphthyl)-4,6-bis(trichloromethyl)-s-triazine and 2-(6′-nitro-1′-naphthyl)-4,6-bis(trichloromethyl)-s-triazine.

The mixture may further comprise at least one solvent (C). These can be, for example, esters, such as butyl acetate or ethyl acetate, aromatic or (cyclo)aliphatic hydrocarbons, such as xylene, toluene or heptane, ketones, such as acetone, isobutyl methyl ketone, methyl ethyl ketone or cyclohexanone, alcohols such as ethanol, isopropanol, mono- or lower oligo-ethylene or propylene glycols, mono- or dietherified ethylene or propylene glycol ethers, glycol ether acetates, such as methoxypropyl acetate, cyclic ethers such as tetrahydrofuran, carboxamides such as dimethylformamide or N-methylpyrrolidone and/or water, for example.

Preferred mixtures of the invention are composed of
at least one component (A) of the formula ¹/ₘ An^{m-} Cya⁺ as indicated above,
at least one component (B), preferably of the formula (VII), with a counterion ¹/ₓ cat^{x+}, and
if appropriate, at least one solvent (C).

In one preferred embodiment the mixtures of the invention are used without solvent (C).

The weight ratio between component (A) of the formula ¹/ₘ An^{m-} Cya⁺ and component (B) of the formula (VII) with counterion ¹/ₓ cat^{x+} in the mixtures of the invention is preferably 1:1 to 1:5, more preferably 1:1 to 1:4, very preferably 1:2 to 1:4.

The mixtures of the invention are highly soluble in coating materials. The solubility can be influenced by the choice of anion and by the choice of the substituents on the cation. Longer alkyl chains as groups R¹⁰, R¹¹ and/or R¹² and/or as substituents on the cyanine generally also lead to better solubility.

The sensitizer dyes of the invention generally have absorption maxima in the wavelength range from 700 nm to 1200 nm. The absorption maximum of the sensitizer dye can be influenced by the skilled worker in a manner known in principle through the choice of the substituents on the cyanine cation.

The NIR radiation used for photocuring can be broadband radiation such as that from light-emitting diodes (LEDs), halogen lamps, Xe lamps, etc. It can also be narrowband radiation or can be laser radiation of a specific wavelength. Particularly suitable lasers are the known lasers which emit in the NIR range, examples being semiconductor diode lasers. The radiation can be supplied continuously or in pulses, for example in the form of flashes.

The present invention further provides radiation-curable coating materials which comprise the mixtures of the invention.

Coating materials of this kind typically comprise
at least one component (A) of the formula ¹/ₘ An^{m-} Cya⁺ as indicated above,
at least one component (B), preferably of the formula (VII), with a counterion ¹/ₓ cat^{x+},
if appropriate at least one solvent (C),
at least one binder (D),
if appropriate at least one reactive diluent (E),
if appropriate at least one UV photoinitiator (F),
if appropriate at least one colorant (G), and
if appropriate further typical coatings additives (H).

Binders (D) are compounds having free-radically or cationically polymerizable ethylenically unsaturated groups. The radiation-curable material comprises preferably 0.001 to 12, more preferably 0.1 to 8 and very preferably 0.5 to 7 mol of radiation-curable ethylenically unsaturated groups per 1000 g of radiation-curable compounds.

Suitable radiation-curable compounds include, for example, (meth)acrylic compounds, vinyl ethers, vinyl amides, unsaturated polyesters, based for example on maleic acid or fumaric acid, or maleimide/vinyl ether systems.

Preference is given to (meth)acrylate compounds such as polyester (meth)acrylates, polyether (meth)acrylates, urethane (meth)acrylates, epoxy (meth)acrylates, carbonate (meth)acrylates, silicone (meth)acrylates and acrylated polyacrylates.

Preferably at least 40 mol %, more preferably at least 60%, of the radiation-curable ethylenically unsaturated groups are (meth)acrylic groups.

The radiation-curable compounds may be in the form, for example, of a solution, in an organic solvent or water, for example, or in the form of an aqueous dispersion or a powder.

Preference is given to those radiation-curable compounds, and hence also those radiation-curable materials, which are fluid at room temperature. It may, though, also be advantageous to apply the radiation-curable compound or coating material as a melt or powder (powder coating material). The radiation-curable materials comprise preferably less than 20%, in particular less than 10%, by weight of organic solvents and/or water. Preferably they are solvent-free and water-free (i.e., 100% systems). In this case it is possible with preference to dispense with a drying step.

Reactive diluents (E) are, for example, esters Of (meth)acrylic acid with alcohols having 1 to 20 carbon atoms, examples being methyl (meth)acrylate, ethyl (meth)acrylate, butyl (meth)acrylate, 2-ethylhexyl (meth)acrylate, 2-hydroxyethyl acrylate, 4-hydroxybutyl acrylate, dihydrodicyclopentadienyl acrylate, vinylaromatic compounds, examples being styrene and divinylbenzene, α,β-unsaturated nitriles, examples being acrylonitrile and methacrylonitrile, α,β-unsaturated aldehydes, examples being acrolein and methacrolein, vinyl esters, examples being vinyl acetate and vinyl propionate, halogenated ethylenically unsaturated compounds, examples being vinyl chloride and vinylidene chloride, conjugated unsaturated compounds, examples being butadiene, isoprene and chloroprene, monounsaturated compounds, examples being ethylene, propylene, 1-butene, 2-butene and isobutene, cyclic monounsaturated compounds, examples being cyclopentene, cyclohexene and cyclododecene; N-vinylformamide, allylacetic acid, vinylacetic acid, monoethylenically unsaturated carboxylic acids having 3 to 8 carbon atoms and also their water-soluble alkali metal, alkaline earth metal or ammonium salts, such as, for example: acrylic acid, methacrylic acid, dimethylacrylic acid, ethacrylic acid, maleic acid, citraconic acid, methylenemalonic acid, crotonic acid, fumaric acid, mesaconic acid and itaconic acid, N-vinylpyrrolidone, N-vinyl lactams, an example being N-vinylcaprolactam. N-vinyl-N-alkyl-carboxamides or N-vinylcarboxamides, such as N-vinylacetamide. N-vinyl-N-methylformamide and N-vinyl-N-methylacetamide, or vinyl ethers, examples being methyl vinyl ether, ethyl vinyl ether, n-propyl vinyl ether, isopropyl vinyl ether, n-butyl vinyl ether, sec-butyl vinyl ether, isobutyl vinyl ether, tent-butyl vinyl ether, 4-hydroxybutyl vinyl ether, and also mixtures thereof.

(Meth)acrylic acid stands in this specification for methacrylic acid and acrylic acid, preferably for acrylic acid.

As UV photoinitiators (F) it is possible to use those photoinitiators that are known to the skilled worker, examples being those specified in “Advances in Polymer Science”, Volume 14, Springer Berlin 1974 or in K. K. Dietliker, Chemistry and Technology of UV and EB Formulation for Coatings, Inks and Paints. Volume 3; Photoinitiators for Free Radical and Cationic Polymerization, P. K. T. Oldring (Eds.), SITA Technology Ltd, London. In contrast to the NIR photoinitiators, the UV photoinitiators are excited substantially by light in the wavelength range of λ=200 to 700 nm, more preferably of λ=200 to 500 nm and very preferably of λ=250 to 400 nm.

In accordance with the invention this comprehends those photoinitiators which release free radicals on exposure to light and are able to initiate a free-radical reaction, such as free-radical polymerization for example.

Suitable examples include phosphine oxides, benzophenones, α-hydroxy-alkyl aryl ketones, thioxanthones, anthraquinones, acetophenones, benzoins and benzoin ethers, ketals, imidazoles or phenylglyoxylic acids, and mixtures thereof.

Phosphine oxides are, for example, mono- or bisacylphosphine oxides, as described for example in EP-A 7 508, EP-A 57 474, DE-A 196 18 720, EP-A 495 751 or EP-A 615 980, examples being 2,4,6-trimethylbenzoyldiphenylphosphine oxide, ethyl 2,4,6-trimethylbenzoylphenylphosphinate or bis(2,6-dimethoxybenzoyl)-2,4,4-trimethyl-pentylphosphine oxide,

benzophenones are, for example, benzophenone, 4-aminobenzophenone, 4,4′-bis(dimethylamino)benzophenone, 4-phenylbenzophenone, 4-chlorobenzophenone, Michler's ketone, o-methoxybenzophenone, 2,4,6-trimethylbenzophenone, 4-methylbenzophenone, 2,4-dimethylbenzophenone, 4-isopropylbenzophenone, 2-chlorobenzophenone, 2,2′-dichlorobenzophenone, 4-methoxybenzophenone, 4-propoxybenzophenone or 4-butoxybenzophenone;
α-hydroxy-alkyl aryl ketones are, for example, 1-benzoylcyclohexan-1-ol (1-hydroxycyclohexyl phenyl ketone), 2-hydroxy-2,2-dimethylacetophenone (2-hydroxy-2-methyl-1-phenylpropan-1-one), 1-hydroxyacetophenone, 1-[4-(2-hydroxyethoxy)phenyl]-2-hydroxy-2-methyl-1-propan-1-one or a polymer comprising 2-hydroxy-2-methyl-1-(4-isopropen-2-ylphenyl)propan-1-one in copolymerized form
xanthones and thioxanthones are, for example, 10-thioxanthenone, thioxanthen-9-one, xanthen-9-one, 2,4-dimethylthioxanthone, 2,4-diethylthioxanthone, 2,4-diisopropylthioxanthone, 2,4-dichlorothioxanthone or chloroxanthenone;
anthraquinones are, for example, β-methylanthraquinone, tert-butylanthraquinone, anthraquinonecarboxylic esters, benz[de]anthracen-7-one, benz[a]anthracene-7,12-dione, 2-methylanthraquinone, 2-ethylanthraquinone, 2-tert-butylanthraquinone, 1-chloroanthraquinone or 2-amylanthraquinone,
acetophenones are, for example, acetophenone, acetonaphthoquinone, valerophenone, hexanophenone, α-phenylbutyrophenone, p-morpholinopropiophenone, dibenzosuberone, 4-morpholinobenzophenone, p-diacetylbenzene, 4′-methoxyacetophenone, α-tetralone, 9-acetylphenanthrene, 2-acetylphenanthrene, 3-acetylphenanthrene, 3-acetylindole, 9-fluorenone, 1-indanone, 1,3,4-triacetylbenzene, 1-acetonaphthone, 2-acetonaphthone, 2,2-dimethoxy-2-phenylacetophenone, 2,2-diethoxy-2-phenylacetophenone, 1,1-dichloroacetophenone, 1-hydroxyacetophenone, 2,2-diethoxyacetophenone, 2-methyl-1-[4-(methylthio)phenyl]-2-morpholinopropan-1-one, 2,2-dimethoxy-1,2-diphenylethan-2-one or 2-benzyl-2-dimethylamino-1-(4-morpholinophenyl)butan-1-one,
benzoins and benzoin ethers are, for example, 4-morpholinodeoxybenzoin, benzoin, benzoin isobutyl ether, benzoin tetrahydropyranyl ether, benzoin methyl ether, benzoin ethyl ether, benzoin butyl ether, benzoin isopropyl ether or 7H-benzoin methyl ether; or
ketals are, for example, acetophenone dimethyl ketal, 2,2-diethoxyacetophenone, or benzil ketals, such as benzil dimethyl ketal.

Phenylglyoxylic acids are described for example in DE-A 198 26 712, DE-A 199 13 353 or WO 98/33761.

Photoinitiators which can be used additionally are, for example, benzaldehyde, methyl ethyl ketone, 1-naphthaldehyde, triphenylphosphine, tri-o-tolylphosphine or 2,3-butanedione.

Typical mixtures comprise, for example, 2-hydroxy-2-methyl-1-phenylpropan-2-one and 1-hydroxycyclohexyl phenyl ketone, bis(2,6-dimethoxybenzoyl)-2,4,4-trimethyl-pentylphosphine oxide and 2-hydroxy-2-methyl-1-phenylpropan-1-one, benzophenone and 1-hydroxycyclohexyl phenyl ketone, bis(2,6-dimethoxybenzoyl)-2,4,4-trimethyl-pentylphosphine oxide and 1-hydroxycyclohexyl phenyl ketone, 2,4,6-trimethylbenzoyl-diphenylphosphine oxide and 2-hydroxy-2-methyl-1-phenylpropan-1-one, 2,4,6-trimethylbenzophenone and 4-methylbenzophenone, or 2,4,6-trimethylbenzophenone and 4-methylbenzophenone and 2,4,6-trimethylbenzoyldiphenylphosphine oxide.

In one preferred embodiment of the present invention at least one UV photoinitiator is present in the coating materials of the invention.

Colorant (G) is used comprehensively for the purposes of this specification for pigments and dyes, preferably for pigments.

Pigments (G) are, according CD Römpp Chemie Lexikon—Version 1.0, Stuttgart/New York: Georg Thieme Verlag 1995, with reference to DIN 55943, particulate “organic or inorganic, chromatic or achromatic colorants which are virtually insoluble in the application medium”.

Virtually insoluble here means a solubility at 25° C. of less than 1 g/1000 g of application medium, preferably below 0.5, more preferably below 0.25, very preferably below 0.1 and in particular below 0.05 g/1000 g of application medium.

Examples of pigments in the true sense comprise any desired systems of absorption pigments and/or effect pigments, preferably absorption pigments. The number and selection of the pigments are not subject to any restrictions whatsoever. They may be adapted to the particular requirements, such as the desired color impression, for example, in an arbitrary way. By way of example it is possible for all of the pigment components of a standardized paint mixer system to be taken as the basis.

By effect pigments are meant all pigments which exhibit a platelet-shaped construction and impart specific decorative color effects to a surface coating. The effect pigments are, for example, all of the effect-imparting pigments which can be employed commonly in vehicle finishing and industrial coating. Examples of effect pigments of this kind are pure metal pigments, such as, for example, aluminum, iron or copper pigments; interference pigments, such as titanium dioxide-coated mica, iron oxide-coated mica, mixed oxide-coated mica (e.g., with titanium dioxide and Fe₂O₃ or titanium dioxide and Cr₂O₃), metal oxide-coated aluminum, or liquid-crystal pigments.

The color-imparting absorption pigments are, for example, customary organic or inorganic absorption pigments which can be used in the paint industry. Examples of organic absorption pigments are azo pigments, phthalocyanine pigments, quinacridone pigments and pyrrolopyrrole pigments. Examples of inorganic absorption pigments are iron oxide pigments, titanium dioxide and carbon black.

Dyes are likewise colorants and differ from the pigments in their solubility in the application medium, i.e., they have a solubility at 25° C. of more than 1 g/1000 g in the application medium.

Examples of dyes are azo, azine, anthraquinone, acridine, cyanine, oxazine, polymethine, thiazine and triarylmethane dyes. These dyes can be employed as basic or cationic dyes, mordant dyes, direct dyes, disperse dyes, developing dyes, vat dyes, metal complex dyes, reactive dyes, acid dyes, sulfur dyes, coupling dyes or substantive dyes.

As further, typical coatings additives (H) it is possible to make use for example of antioxidants, stabilizers, activators (accelerants), fillers, antistats, flame retardants, thickeners, thixotropic agents, surface-active agents, viscosity modifiers, plasticizers or chelating agents.

As accelerants for the thermal aftercure it is possible to use, for example, tin octoate, zinc octoate, dibutyltin laurate or diazabicyclo[2.2.2]octane.

In addition it is possible to add one or more photochemically and/or thermally activable initiators, examples being potassium peroxodisulfate, dibenzoyl peroxide, cyclohexanone peroxide, di-tert-butyl peroxide, azobisisobutyronitrile, cyclohexylsulfonyl acetyl peroxide, diisopropyl percarbonate, tert-butyl peroctoate or benzpinacol, and also, for example, those thermally activable initiators which have a half-life at 80° C. of more than 100 hours, such as di-t-butyl peroxide, cumene hydroperoxide, dicumyl peroxide, t-butyl perbenzoate, silylated pinacols, which are available commercially, for example, under the trade name ADDID 600 from Wacker, or hydroxyl-containing amine N-oxides, such as 2,2,6,6-tetramethylpiperidine-N-oxyl, 4-hydroxy-2,2,6,6-tetra-methyl-piperidine-N-oxyl, etc.

Further examples of suitable initiators are described in “Polymer Handbook”, 2nd ed., Wiley & Sons, New York.

Suitable thickeners, besides free-radically (co)polymerizable (co)polymers, include customary organic and inorganic thickeners such as hydroxymethylcellulose or bentonite.

Examples of chelating agents which can be used include ethylenediamineacetic acid and its salts and also β-diketones.

Coloristically inert fillers are all substances/compounds which on the one hand are coloristically inactive—that is, they exhibit little intrinsic absorption and have a refractive index similar to that of the coating medium—and on the other hand are capable of influencing the orientation (parallel alignment) of the effect pigments in the surface coating, i.e., in the applied paint film, and also properties of the coating or of the coating materials, such as hardness or rheology. Inert substances/compounds which can be used are given by way of example below, but without restricting the concept of coloristically inert, topology-influencing fillers to these examples. Suitable inert fillers meeting the definition may be, for example, transparent or semitransparent fillers or pigments, such as, for example, plastic granules, silica gels, blanc fixe, kieselguhr, talc, calcium carbonates, lime, kaolin, barium sulfate, magnesium silicate, aluminum silicate, crystalline silicon dioxide, amorphous silica, or aluminum oxide. Additionally as inert fillers it is possible to employ any desired solid inert organic particles, such as urea-formaldehyde condensates, micronized polyolefin wax and micronized amide wax, for example. The inert fillers can in each case also be used in a mixture. It is preferred, however, to use only one filler in each case.

Suitable stabilizers comprise typical UV absorbers such as oxanilides, triazines and benzotriazole and benzophenones. These can be used alone or together with suitable free-radical scavengers, examples being sterically hindered amines such as 2,2,6,6-tetramethylpiperidine, 2,6-di-tert-butylpiperidine or derivatives thereof, e.g., bis(2,2,6,6-tetramethyl-4-piperidyl) sebacate. Stabilizers are customarily used in amounts of 0.1% to 5.0% by weight, based on the solid components comprised in the preparation.

The mixtures of the present invention can be used as NIR-activable photoinitiators and exhibit better solubility in coating materials and paint systems than the prior-art formulations of NIR photoinitiators in which borate ions of the formula (VII) function as the counterion for the cyanine cation. The consequence of this is that, on the one hand, the photoinitiator can be distributed more uniformly in the paint system, and no undissolved particles remain as defects in the subsequent paint, and that, on the other hand, a higher photoreactivity results. In the prior-art NIR photoinitiators the compounds to some extent precipitate as crystals in the coating material, owing to the inadequate solubility.

To achieve this improved solubility the mixtures of the invention are blended with radiation-curable compounds, i.e., for example, binders (D) and/or reactive diluents (E), or preparations comprising them, such as coating materials, paints or paint formulations, for example.

In another embodiment of the invention it is possible to blend radiation-curable compounds with at least one component (A) of the formula ¹/ₘ An^{m-} Cya⁺ as defined above, optionally in dilution in a solvent, and, separately therefrom, with at least one component (B) of the formula (VII) having a counterion ¹/ₓ cat^{x+}, optionally in dilution in a solvent.

In accordance with the invention it is not important in which way blending takes place. It can be effected, for example, with a mechanical stirrer, such as disk, inclined-blade, anchor, intensive or gas-dispersion stirrer, or else by pumped circulation, if appropriate through a slotted baffle, or in a mixing pump, or else, often, by simple mixing of the two components by hand or by shaking. It is of course also possible, however, to use mixing techniques entailing higher shear energy, such as jet dispersion, intensive dispersion, Ultraturrax dispersion or ultrasonic dispersion, for example.

It is a particular advantage of the NIR photoinitiators that photoinitiators of this kind are able to initiate a free-radical polymerization even in pigmented paints, since the activating radiation is generally absorbed only little, or not at all, by pigments, whereas the UV radiation required to activate UV photoinitiators is normally absorbed and/or scattered by the pigments and therefore has a low depth of penetration into the coating. Accordingly it is a preferred embodiment of the present invention to use the mixtures of the invention in pigmented coating materials.

A further advantageous embodiment of the present invention involves using the mixtures of the invention in coating materials with high coat thicknesses. Thus in one preferred embodiment the mixtures will be used in coating materials which exhibit a coat thickness of more than 30 μm, preferably more than 45 μm and more preferably more than 60 μm. The coating materials may have a thickness of up to 300 μm, preferably up to 250 μm and more preferably up to 200 μm.

It is of course also possible to apply the coatings more thickly or thinly, at from 10 to 1000 μm for example. In the case of coating materials applied very thickly, however, it may be necessary to irradiate two or more times.

The radiation-curable coating material can be applied preferably in a simple way, as for example by spraying, trowelling, spreading, knifecoating, brushing, rolling, rollercoating, pouring, dipping, laminating, injection-bat molding or coextruding, etc., to the article to be coated, and, if appropriate, can be dried.

Curing is effected by irradiation using electromagnetic radiation which comprises the visible range and the NIR range, preferably the NIR range, and more preferably using electromagnetic radiation in the wavelength range of 700-900 nm.

In one preferred embodiment of the invention the irradiation may also be carried out in the absence of oxygen. For that purpose irradiation is carried out such that at the moment of its irradiation with NIR radiation the coating material is exposed to an oxygen partial pressure of less than 18 kPa. The relevant regions are the surface regions of the article to be coated that are provided with the radiation-curable coating materials, at the moment of irradiation. Preferably the oxygen partial pressure is not more than 17 kPa, more preferably not more than 15.3 kPa, very preferably not more than 13.5 kPa, in particular not more than 10 kPa, and especially not more than 6.3 kPa.

Complete absence of oxygen is often unnecessary, and so the oxygen partial pressure need not be below, preferably, 0.5 kPa, more preferably 0.9 kPa, very preferably 1.8 kPa, and in particular 2.5 kPa.

One observed advantage of curing under low oxygen partial pressures is, for example, an improved scratch resistance.

A low oxygen partial pressure of this kind can be obtained advantageously by diluting the oxygen-containing atmosphere with at least one inert gas or replacing it by at least one inert gas, in other words gases which are unreactive under the conditions of radiation curing. Suitable inert gases include, preferably, nitrogen, noble gases, carbon dioxide or combustion gases. In the atmosphere under which the radiation cure is carried out, the fraction of said at least one inert gas ought to be more than 80% by volume, preferably at least 85%, more preferably at least 90%, very preferably at least 95%, and in particular at least 98% by volume. Irradiation may additionally take place with the coating material covered by transparent media. Transparent media are, for example, polymeric films, glass or liquids, e.g., water. Irradiation takes place with particular preference as described in WO 01/14483, hereby incorporated in its entirety by reference. Very particular preference is given to irradiation in the manner described in DE-A1 199 57 900, hereby incorporated in its entirety by reference.

The coating materials and paint formulations of the invention are especially suitable for coating substrates such as wood, preferably pine, fir, beech, oak or maple, paper, cardboard, paperboard, textile, leather, leather substitutes, nonwoven, plastics surfaces, preferably SAN, PMMA, ABS, PP, PS, PC or PA (abbreviations to DIN 7728), glass, ceramic, mineral building materials, such as cement moldings and fiber-cement slabs, or uncoated or coated metals, preferably plastics or metals, which may also be in the form of sheets (foils or films), for example. The coated or uncoated metal may also have been formed, for the purpose for example of storage or transport, into rolls, referred to as “coils”. The coating of the metals may comprise typical primer coatings or a cathodic deposition coating system.

With particular preference the coating materials of the invention are suitable for outdoor applications or in applications involving exposure to daylight, preferably of buildings or parts of buildings, for interior coatings, and coatings on aircraft and vehicles. In particular the coating materials of the invention are used as or in automotive clearcoat and topcoat material(s) and also in paints especially exterior architectural paints, industrial coatings, coil coatings, molding compounds, casting compounds or dental compounds. A further possibility is to use the mixtures of the invention to cure building materials, tiles, clinker, artificial stone, screeding, plasters and coating materials for the purpose of their coating. With advantage the coating materials of the invention can be used for decorative coating, especially for furniture, woodblock floor, laminate and floorcovering coating.

A further possibility is to use the coating materials of the invention in printing processes or for producing printing plates, as for example in stereolithography, photolithography, in screenprinting, offset printing, planographic printing, gravure printing or relief printing processes and also in the ink-jet processes.

The examples which follow are intended to illustrate the properties of the invention, but without restricting it.

By “parts” or “%” are meant in this specification, unless indicated otherwise, “parts by weight” or “% by weight”.

The synthesized inventive NIR sensitizers A1 to A10 are summarized in Table 1. Serving as comparative examples are the noninventive NIR dyes in the form of the corresponding iodides (B1 to B10).

The inventive NIR absorbers can be synthesized in a two-stage process. In the first stage the synthesis takes place of the cyanine cations with customary anions, such as iodide, for example. The synthesis is known in principle to the skilled worker and can be carried out according to syntheses known from the literature, e.g., according to the instructions of K. Venkataraman “The Chemistry of Synthetic Dyes”, Academic Press, New York, 1952, Vol. II and H. Zollinger “Color Chemistry: Synthesis, Properties, and Applications of Organic Dyes and Pigments”, Weinheim, Wiley-VCH, 2003.

In a second stage the customary anion is replaced by an inventive anion.

### EXAMPLES

A range of inventive NIR sensitizers having improved solubilities was synthesized.

1st Stage: Synthesis of Cyanine Cations with Customary Anions

Described below by way of example is the synthesis of the absorber 2-[2-[2-[2-(1,3-dihydro-1-ethyl-3,3-dimethyl-2H-indol-2-ylidene)ethylidene]-1-cyclohexen-1-yl]ethenyl]-1-ethyl-3,3-dimethyl-3H-indolium iodide (B1).

10 g (0.032 mol) of 3-ethyl-1,1,2-trimethylindolium iodide and 2.7 g (0.016 mol) of 3-hydroxymethylenecyclohex-1-enecarbaldehyde were introduced initially in a mixture of 105 ml of butanol and 45 ml of toluene. This initial charge was heated to 110° C. and the water formed was removed. After five hours of stirring the solution was cooled to room temperature. It was concentrated and then methyl tert-butyl ether was added. The crystals formed were isolated by suction filtration and washed with methyl tert-butyl ether. 9.4 g of crystals were obtained, which were dried under reduced pressure at 50° C. (m.p. 235° C.).

In a similar way, using corresponding starting compounds, other cyanine cations with customary anions were synthesized.

2nd stage: General Instructions for Preparing Inventive NIR Sensitizers by Replacement of the Anion

### 2-[2-[2-[2-(1,3-Dihydro-1-ethyl-3-3-dimethyl-2H-indol-2-ylidene)ethylidene]-1-cyclohexen-1-yl]ethenyl]-1-ethyl-3,3-dimethyl-3H-indolium dodecylsulfonate (A1)

The compound was prepared as follows: 0.003 mol (1.6 g) of the NIR sensitizer A1 were introduced initially together with 0.009 mol (2.3 g) of Na dodecylsulfonate in 50 ml of dichloromethane. 50 ml of water were added, the mixture was stirred at room temperature for 30 minutes, and finally the phases were separated. The organic phase was washed three times with 50 ml of water until iodide was no longer detectable, using silver nitrate solution, in the wash water. After the organic phase had been dried using sodium sulfate the solvent was removed by distillation and the residue was dried under reduced pressure at 50° C.

In a similar way, using other cyanine cations and corresponding salts of the desired anions, the following NIR sensitizers were prepared. The inventive NIR sensitizers synthesized are summarized in table 1.

TABLE 1
Synthesized inventive NIR sensitizers (A)

| | λₘₐₓ | | |
|---|---|---|---|
| Compound | [nm] | Cyanine cation | Anion |
| A1 | 786 | 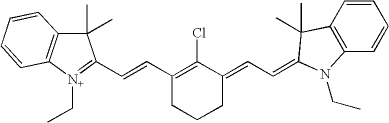 | 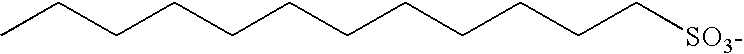 |
| A2 | 786 | 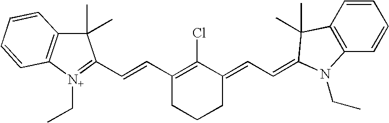 | 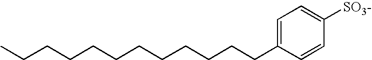 |
| A3 | 810 | 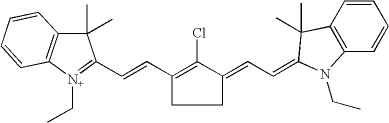 | 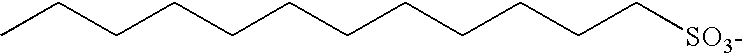 |
| A4 | 810 | 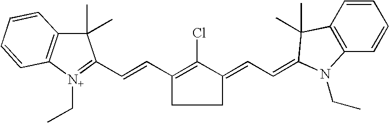 | 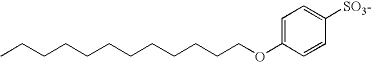 |
| A5 | 832 | 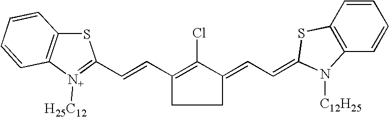 | 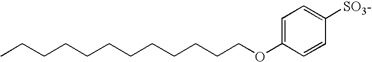 |
| A6 | 810 | 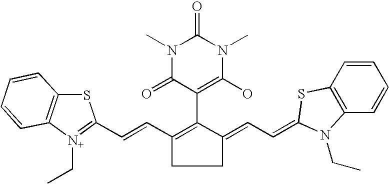 | 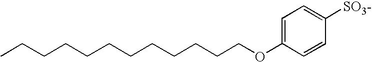 |
| A7 | 762 | 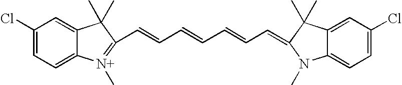 | 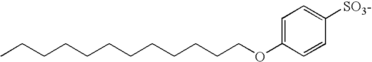 |
| A8 | 823 | 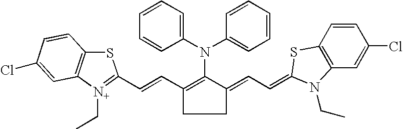 | 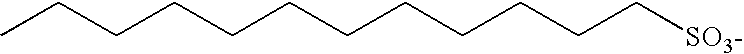 |
| A9 | 676 | 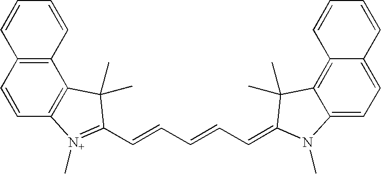 | 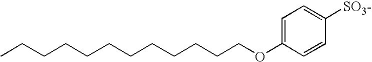 |
| A10 | 768 | 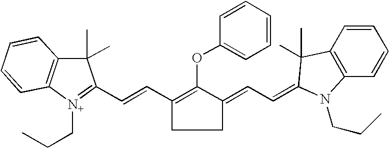 | 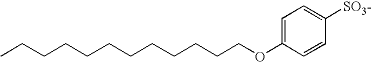 |
| A11 | 782 | 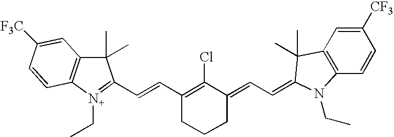 | 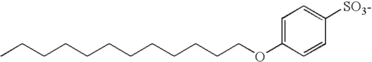 |
| A12 | 792 | 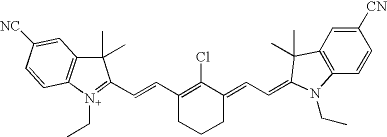 | 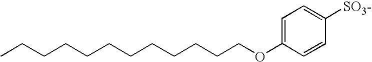 |

Comparison purposes were served by a range of noninventive NIR sensitizers (the iodide salts analogous to A1-A10).

TABLE 2
Synthesized noninventive NIR sensitizers (B)

| Compound | λₘₐₓ | | Anion |
|---|---|---|---|
| B1-B12 | see table 1 | for cyanine cation see table 1 | I⁻ |

### Coinitiator X Used:

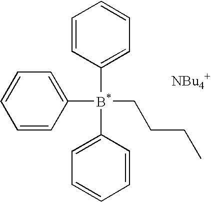

Comparison of solubilities of the NIR sensitizers in paint base materials:

The tests were carried out using two customary free-radically polymerizable paint base materials of the acrylate type (Laromer® LR 8863 and Laromer® LR PO84F, both from BASF AG). Defined amounts of each of the NIR sensitizers were added to these base materials, and the resulting mixtures were stirred at room temperature for at least 4 hours. Polarization microscopy was used to test whether the resultant liquids still comprise undissolved crystals of the NIR sensitizer.

The noninventive NIR sensitizers B7, B11 and B12 were insufficiently soluble in both solutions (solubility in each case<0.1% by weight).

With the inventive NIR sensitizers A7, A11 and A12, in contrast, clear solutions with no undissolved crystals were obtained even with 0.5% by weight of the corresponding NIR sensitizer.

### Testing of the NIR Sensitizers in Photoinitiator Mixtures:

The two aforementioned paint base materials were admixed with 0.5% by weight of each NIR sensitizer and 1.5% by weight of the boronate salt X⁻ and the mixtures were stirred intensively. Thin coats (coat thickness approximately 50 μm) were produced with the resulting mixtures between two glass plates, using spacer sheets. These coats were exposed using a 250 W halogen lamp (distance approximately 15 cm) for 1 minute.

### Comparative Examples

The noninventive NIR sensitizers B7, B11 and B12 were each not completely dissolved in the paint base material. Following exposure, an incompletely cured paint film was obtained. In addition, there were colored specks in the varnish (undissolved crystals under the polarization microscope).

### Inventive Examples

The inventive NIR sensitizers A7, A11 and A12 were each fully dissolved in the paint base material. After an exposure time of just 4 seconds a hard, clear varnish film with no specks was obtained.

1-15. (canceled)

16. A mixture comprising
(A) at least one sensitizer, ionic in construction, comprising at least one cyanine cation Cya⁺ and at least one corresponding anion ¹/ₘ An^{m-}, the cyanine cation having a general formula (I), (II), (III) or (IV) 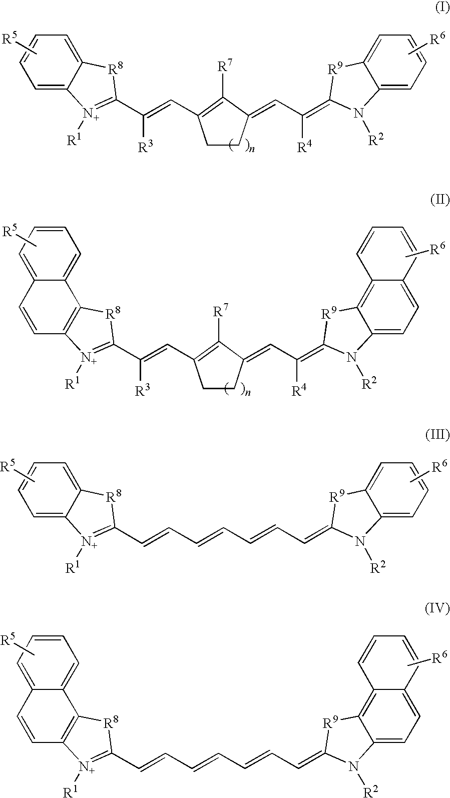
in which
n is 1 or 2 and the radicals R¹ to R⁹ are defined as follows:
R¹ and R² independently of one another are each a linear or branched, optionally further-substituted alkyl or aralkyl radical having 1 to 20 carbon atoms,
R³ and R⁴ independently of one another are each H, CF₃ or CN,
R⁵ and R⁶ independently of one another are one or more identical or different substituents selected from the group consisting of —H, —F, —Cl, —Br, —I, —NO₂, —CN, —CF₃, —SO₂CF₃, —R¹, —OR¹, aryl and —O-aryl,
R⁷ is —H, —Cl, —Br, —I, -phenyl, —O-phenyl, —S-phenyl, —N(phenyl)₂, -pyridyl, a barbituric acid radical or a dimedone radical, it also being possible for the phenyl radicals to be further substituted, and
R⁸ and R⁹ independently of one another are each >C(CH₃)₂, —O—, —S—, >NR¹ or —CH═CH—,
and either the anion An^{m-} having the general formula [AR¹⁰ₖ]^{m-} with at least one polar ionic head group A and k nonpolar groups R¹⁰, in which
k is a number 1, 2 or 3,
m is 1 or 2,
and the nonpolar groups R¹⁰ are alkylaryl groups of the general formula -aryl-R¹¹, R¹¹ being linear or branched alkyl groups having 3 to 30 carbon atoms,
or the anion An^{m-} being a borate anion of the general formula (V) or (VI) 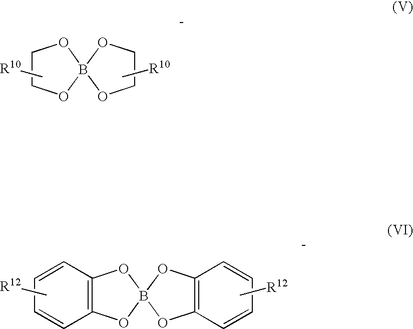
where R¹⁰ is as defined above and R¹² is at least one substituent selected from the group consisting of hydrogen and linear, cyclic or branched alkyl groups having 1 to 20 carbon atoms, and
it also being possible, in the radicals R¹⁰, R¹¹ and R¹², for nonadjacent carbon atoms optionally to be substituted by oxygen atoms, and/or for the radicals R¹⁰, R¹¹ and R¹² to be fully or partly fluorinated, with the proviso that this does not substantially affect the nonpolar nature of the groups, and
(B) at least one coinitiator selected from the group consisting of alkyl-substituted boronate salts, sulfonium salts, iodonium salts, sulfones, peroxides, pyridine N-oxides and halomethyltriazines.

17. A mixture composed of
at least one component (A) of the formula ¹/ₘ An^{m-} Cya⁺ as defined in claim 1,
at least one coinitiator (B) selected from the group consisting of alkyl-substituted boronate salts, sulfonium salts, iodonium salts, sulfones, peroxides, pyridine N-oxides and halomethyltriazines, and
if appropriate at least one solvent (C).

18. A coating material comprising
at least one component (A) of the formula ¹/ₘ An^{m-} Cya⁺ as defined in claim 1,
at least one coinitiator (B) selected from the group consisting of alkyl-substituted boronate salts, sulfonium salts, iodonium salts, sulfones, peroxides, pyridine N-oxides and halomethyltriazines,
if appropriate at least one solvent (C),
at least one binder (D),
if appropriate at least one reactive diluent (E),
if appropriate at least one UV photoinitiator (F),
if appropriate at least one colorant (G), and
if appropriate further typical coatings additives (H).

19. The mixture according to claim 16, wherein the coinitiator (B) is a compound of the formula (VII), 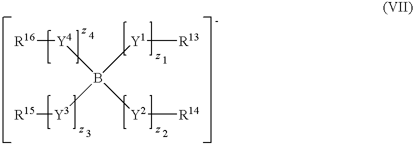
with an associated counterion ¹/ₓ cat^{x+},
in which
x is 1 or 2,
cat is an x-valent cation,
z¹, z², z³ and z⁴ independently of one another are each 0 or 1,
the sum z¹+z²+z³+z⁴ being 0, 1, 2 or 3,
Y¹, Y², Y³ and Y⁴ independently of one another are each O, S or NR¹⁷,
R¹³, R¹⁴, R¹⁵ and R¹⁶ independently of one another are each C₁-C₁₈ alkyl, C₂-C₁₈ alkyl optionally interrupted by one or more oxygen and/or sulfur atoms and/or by one or more substituted or unsubstituted imino groups, or are each C₆-C₁₂ aryl, C₅-C₁₂ cycloalkyl or a five- to six-membered heterocycle containing oxygen, nitrogen and/or sulfur atoms, it being possible for the stated radicals to be substituted in each case by aryl, alkyl, aryloxy, alkyloxy, heteroatoms and/or heterocycles, and
R¹⁷ is hydrogen, C₁-C₁₈ alkyl or C₆-C₁₂ aryl,
with the proviso that at least one of the radicals R¹³ to R¹⁶ is a C₁-C₁₈ alkyl radical and at least one of the radicals R¹³ to R¹⁶ is a C₆-C₁₂ aryl radical, it being possible for the stated radicals to be substituted in each case by aryl, alkyl, aryloxy, alkyloxy, heteroatoms and/or heterocycles.

20. The mixture according to claim 16, wherein the coinitiator (B) is a compound of the formula 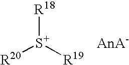
in which
R¹⁸ and R¹⁹ are each an optionally substituted aryl group and
R²⁰ is an optionally substituted alkyl group, an optionally substituted alkenyl group, an optionally substituted alicyclic group, an optionally substituted aryl group or an optionally substituted aralkyl group, and AnA⁻ is an anion.

21. The mixture according to claim 16, wherein the coinitiator (B) is a compound of the formula
R²¹13 I⁺—R²²AnB⁻
in which
R²¹ and R²² are optionally substituted aryl groups and
AnB⁻ is an anion.

22. The mixture according to claim 16, wherein the coinitiator (B) is a compound of the formula 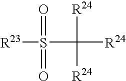
in which
R²³ is an optionally substituted aryl group and the radicals R²⁴ are each a halogen atom.

23. The mixture according to claim 16, wherein the coinitiator (B) is a compound of the formula 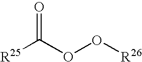
in which
R²⁵ is an optionally substituted aryl group and
R²⁶ is an optionally substituted alkyl group, an optionally substituted aryl group or an optionally substituted benzoyl group.

24. The mixture according to claim 16, wherein the coinitiator (B) is a compound of the formula 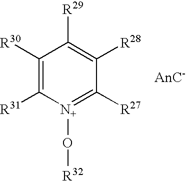
in which
R²⁷, R²⁸, R²⁹, R³⁰ and R³¹ independently of one another are each a hydrogen atom, a halogen atom, a cyano group, an optionally substituted alkyl group, an optionally substituted alkoxy group or an optionally substituted aryl group,
R³² is an optionally substituted alkyl group, and
AnC⁻ is an anion.

25. The mixture according to claim 16, wherein the coinitiator (B) is a compound of the formula 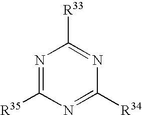
in which
R³³, R³⁴ and R³⁵ independently of one another are each a trihalomethyl group, an optionally substituted alkyl group, an optionally substituted alkenyl group or an optionally substituted aryl group, with the proviso that at least one of the groups R³³, R³⁴ and R³⁵ is a trihalomethyl group.

26. The mixture according to claim 16, wherein the anion An^{m-} has the formula [AR¹⁰ₖ]^{m-} where
K=1 and
R¹⁰=-aryl-R¹¹,
where R¹¹ is a linear or branched alkyl group having 3 to 30 carbon atoms, and A is selected from the group consisting of —SO₃⁻, —OSO₃⁻, —COO⁻, —PO₃²⁻, —OPO₃²⁻ or (—O)PO₂⁻.

27. The mixture according to claim 26, wherein R¹¹ in claim 11 is selected from the group consisting of 1-propyl, 2-propyl, 1-butyl, 2-butyl, tert-butyl, 1-pentyl, 1-hexyl, cyclohexyl, 2-ethyl-1-hexyl, 1-octyl, 1-nonyl, 1-decyl, 1-undecyl, 1-dodecyl, and 1-tetradecyl.

28. The mixture according to claim 16, wherein the anion An^{m-} is a 4-alkylbenzenesulfonate having alkyl radicals of 6 to 12 carbon atoms.

29. The mixture according to claim 16, wherein anion An^{m-} is selected from the group consisting of 4-hexylbenzenesulfonate, 4-octylbenzenesulfonate, 4-decylbenzenesulfonate, and 4-dodecylbenzenesulfonate.

30. A process for preparing a radiation-curable coating material comprising at least one binder (D) and/or at least one reactive diluent (E), which comprises mixing the binder (D) and/or reactive diluent (E) with a mixture according claim 16.

31. A process for preparing a radiation-curable coating material comprising at least one binder (D) and/or at least one reactive diluent (E), which comprises mixing the binder (D) and/or reactive diluent (E) with at least one component (A) of the formula ¹/ₘ An^{m-} Cya⁺ as defined in claim 1 and, separately therefrom, with at least one component (B) selected from the group consisting of alkyl-substituted boronate salts, sulfonium salts, iodonium salts, sulfones, peroxides, pyridine N-oxides and halomethyltriazines.

32. A method of curing a coating material by irradiation with NIR radiation, comprising at least one NIR photoinitiator and at least one free-radically polymerizable compound, which comprises carrying out irradiation under an oxygen partial pressure of less than 18 kPa.

33. The method according to claim 32, wherein said curing is carried out under an atmosphere comprising at least one inert gas.
